(19) United States
(12) Patent Application Publication
(10) Pub. No.: US 2014/0092464 A1
(43) Pub. Date: Apr. 3, 2014

(54) PHOTONIC CRYSTAL DEVICE WITH INFILTRATING COMPONENT

(71) Applicants: Andre Arsenault, Toronto (CA); Eric Arsenault, Calgary (CA); Alison Yee-Shun Cheng, Toronto (CA)

(72) Inventors: Andre Arsenault, Toronto (CA); Eric Arsenault, Calgary (CA); Alison Yee-Shun Cheng, Toronto (CA)

(73) Assignee: OPALUX INCORPORATED, Toronto, ON (CA)

(21) Appl. No.: 13/981,477

(22) PCT Filed: Jan. 25, 2012
(86) PCT No.: PCT/CA2012/000077

§ 371 Date: Dec. 13, 2013

Related U.S. Application Data
(60) Provisional application No. 61/435,832, filed on Jan. 25, 2011.

(51) Int. Cl. G02F 1/01

(52) U.S. Cl. CPC G02F 1/0128; B82Y 20/00
USPC 359/290; 29/428; 977/902

(57) ABSTRACT

A photonic crystal device including a photonic crystal material and an infiltrating component. The photonic crystal material has an initial reflectance spectrum. An external stimulus causes the infiltrating component to migrate into or out of at least a portion of the photonic crystal material. The migration of the infiltrating component causes a change of at least the portion of the photonic crystal material to shift to a second reflectance spectrum.

### CROSS-REFERENCE TO RELATED APPLICATIONS

This disclosure claims priority from U.S. provisional patent application No. 61/435,832, filed Jan. 25, 2011, the entirety of which is hereby incorporated by reference.

### TECHNICAL FIELD

The invention relates to a photonic crystal-based device. In particular, this invention relates to an indicator device that provides a visual signal upon the application of a means of activation.

### BACKGROUND

Photonic crystal (PC) materials are materials having a periodic modulation in their refractive index (Yablonovitch, Phys. Rev. Lett., 58:2059, 1987), giving rise to a photonic band gap or stop gap, in which electromagnetic waves within a certain stop band wavelength range may be mostly or totally reflected. The wavelengths of the stop band may be dependent on the distance between the periodic modulations in the crystal. The reflected stop band wavelengths may appear in the reflectance spectrum as a reflectance peak known as a Bragg peak. A photonic crystal material may have a one-, two-, or three-dimensional periodic structure.

Because of the sensitivity of a PC material, slight changes in the refractive index or lattice spacing may result in optically detectable changes in the reflected light. This may be useful where the reflected light is in the visible range, for example allowing for changes in color if the refractive index or lattice spacing is modulated. One way to adjust the reflectance spectrum (also referred to as “tuning”) of the photonic crystal material may be by incorporating polymers into PC materials, such that the PC material may be made responsive to mechanical stimulation, such as compression. Examples of such an application are given by Arsenault et al. in PCT Patent Application No. WO2008/098339, which is herein incorporated by reference in its entirety.

Another example method for selectively changing the optical properties of a photonic crystal material may be by changing the refractive index of one of more of the components in the photonic crystal material. For example, according to the Bragg-Snell equation (eq 1), the average refractive index (n_{eff}) of a given material may have a direct impact on its reflected wavelength(s). If an example photonic crystal material is composed of two periodically alternating materials (e.g., polymer and air), the refractive index difference, also referred to as the refractive index contrast, between these two components may influence the optical properties of the PC material.

The Bragg-Snell equation is as follows:

λ₍₁₁₁₎=2n_{eff}d₁₁₁ (eq 1)

where λ₍₁₁₁₎ is the spectral position of the reflectance peak arising from coherent diffraction from the (111) crystal planes, n_{eff} is the volume average refractive index of the material, and d₁₁₁ is the lattice spacing along the (111) crystal plane.

The reflectance spectrum of a PC may be altered, for example by changing the refractive index contrast within the PC.

### SUMMARY

In some example aspects, the present disclosure describes examples of an indicator device based on a porous photonic crystal material. The device may include a photonic crystal material that may display a certain initial characteristic reflection peak. The device may also include one or more infiltrating components. The subjection of the device to a predetermined means of activation (e.g., one or more external stimuli) may cause the infiltrating component(s), such as a fluid, to migrate, infiltrate and/or diffuse into or out of at least a portion of the pores of the photonic crystal material, thereby changing the properties of the characteristic reflection peak (including, for example, position, shape, width, and magnitude, among others) and providing an optically detectable (e.g., visually detectable) indication that said means of activation has been triggered.

In some example aspects, the present disclosure provides a photonic crystal device comprising: a photonic crystal material having a periodic difference in refractive indices giving rise to a first reflectance spectrum; and an infiltrating component; wherein an external stimulus causes the infiltrating component to migrate into or out of at least a portion of the photonic crystal material; and wherein the migration of the infiltrating component into or out of at least the portion of the photonic crystal material causes a change of at least the portion of the photonic crystal material resulting in at least the portion of the photonic crystal material exhibiting a change from the first reflectance spectrum to a second reflectance spectrum that is detectably different from the first reflectance spectrum.

In some example aspects, the present disclosure provides a method for manufacturing a photonic crystal device, the method comprising: providing a photonic crystal material having a periodic difference in refractive indices giving rise to a first reflectance spectrum; and coupling an infiltrating component to the photonic crystal material; wherein an external stimulus causes the infiltrating component to migrate into or out of at least a portion of the photonic crystal material, thereby causing a change of at least the portion of the photonic crystal material resulting in at least the portion of the photonic crystal material exhibiting a change from the first reflectance spectrum to a second reflectance spectrum that is detectably different from the first reflectance spectrum.

Examples of the disclosed devices may be useful, for instance, as consumer-protection or food safety devices to provide visual indications of a product being exposed to, for example, undesirable temperatures or excessive storage time and having therefore suffered a loss of quality. Examples of the disclosed devices may also be useful as security/anti-counterfeit/tamper-proof labels or devices on products, consumables, pharmaceuticals, and secure documents.

### BRIEF DESCRIPTION OF THE DRAWINGS

Example embodiments of the present disclosure are described herein with reference to the drawings.

FIG. 1 is a schematic diagram showing an example photonic crystal device with an infiltrating component;

FIG. 2 is a schematic diagram showing another example photonic crystal device with an infiltrating component;

FIG. 3 is a schematic diagram showing another example photonic crystal device with an infiltrating component;

FIG. 4 is a schematic diagram showing another example photonic crystal device with an infiltrating component;

FIG. 5 shows example uses of example photonic crystal devices with infiltrating components;

FIG. 6 shows images showing an example use of an example photonic crystal device with an infiltrating component;

FIG. 7 is a series of images showing the response over time of an example photonic crystal device with an infiltrating component;

FIG. 8 shows images showing an example use of an example photonic crystal device with an infiltrating component;

FIG. 9 shows example reflectivity curves of an example inverse opal photonic crystal material suitable for use in a photonic crystal device with an infiltrating component, before and after infiltration by an infiltrating component;

FIG. 10 shows example reflectivity curves of an example Bragg stack photonic crystal material suitable for use in a photonic crystal device with an infiltrating component, before and after infiltration by an infiltrating component;

FIG. 11 shows example reflectivity curves of the example of FIG. 7, showing example changes that occur when increasing amounts of the infiltrating component migrate into the photonic crystal structure;

FIG. 12 shows an optical microscope image of an example photonic crystal material where only a selective region has been infiltrated with an infiltrating component;

FIG. 13 is a flowchart showing an example method for manufacturing a photonic crystal device with an infiltrating component;

FIG. 14 shows images illustrating the operation of an example photonic crystal device having an infiltrating component, in which the device is responsive to a thermal stimulus;

FIG. 15a shows images illustrating the operation of an example photonic crystal device that is responsive to a thermal stimulus, in which the infiltrating component is patterned and a latent image is encoded;

FIG. 15b shows a diagram illustrating an example method of coating the infiltrating component and an adhesive in complementary patterns on a second substrate in an example photonic crystal device; and

FIG. 16 shows images illustrating the operation of an example photonic crystal device in which a device responsive to a thermal stimulus includes two different infiltrating components.

### DETAILED DESCRIPTION

The reflectance spectrum of a photonic crystal material may be altered, for example by changing the refractive index contrast within the photonic crystal material. Since transmissivity of a material is related to its reflectivity, for example in that wavelengths that a reflected are not transmitted through the material and vice versa, the transmittance spectrum of a photonic crystal material may also be altered when the reflectance spectrum is altered. Such a change in the reflectance and transmittance spectra may be effected, for example, by the migration of one or more substances into or out of the photonic crystal material. The sorption of liquids into conventional porous photonic crystal materials typically has not been controlled or used to display useful information to a user. The present disclosure provides photonic crystal devices based on migration of a component into or out of a photonic crystal material.

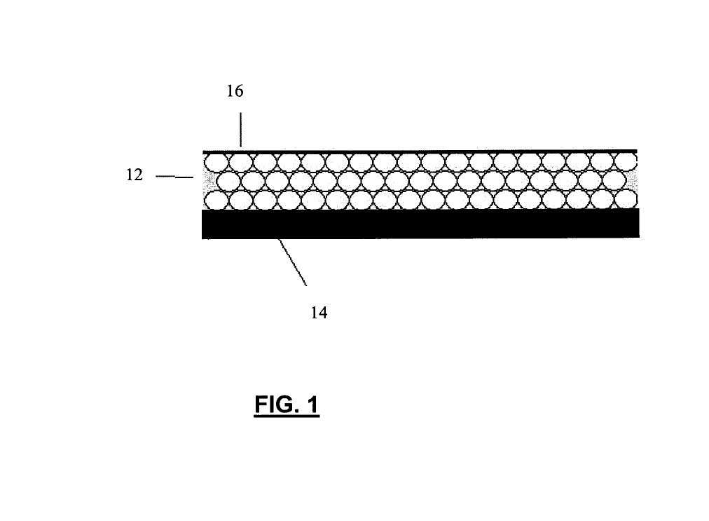

Examples of photonic crystal devices having one or more infiltrating components are described. FIG. 1 shows an example photonic crystal device having an infiltrating component. In this example, the photonic crystal device includes a photonic crystal material 12, an infiltrating component 14 and optionally a protective layer 16. The protective layer 16 may provide a barrier against contaminants (e.g., dust, oil, water, etc.) that may interfere with the operation of the photonic crystal device. The protective layer 16 may be substantially optically transparent, so that the optical effects of the photonic crystal device may be observed. In some examples, the protective layer 16 may not be necessary (e.g., in applications where contaminants are not a concern and/or where the photonic crystal material is not the topmost layer).

The photonic crystal material 12 may have a lattice structure with a periodic modulation in its refractive index (e.g., due to differences in refractive indices of its constituents and/or due to differences in refractive indices between its constituent(s) and air-filled voids). Such periodic modulation, in one-, two- or three-dimensions, may result in initial reflectance and transmittance spectra for the material 12. The wavelengths reflected in the reflectance spectrum and transmitted in the transmittance spectrum may be dependent on, for example, the difference in refractive indices (also referred to as refractive index contrast), the thickness of the photonic crystal material 12, and/or the dimensions of the periodic modulation. For example, the wavelength of light that is reflected may be proportional to the periodicity of the modulation of refractive indices in the photonic crystal material 12. In some examples, the photonic crystal material 12 may be designed (e.g., by selecting the constituent(s) and/or dimension of periodicity) to have initial reflectance and transmittance spectra in a desired wavelength range (e.g., a certain visible wavelength range, which may be observed as a certain initial color).

The photonic crystal material 12 may have an opaline structure, in which the photonic crystal material 12 may have an ordered three-dimensional periodic array of spheres (typically hard, solid spheres) arranged in a crystalline structure (e.g., face-centered cubic structure). In such an example, the initial reflectance peak in the reflectance spectrum may arise from the refractive index contrast between the spheres material and the air voids in the interstices.

In the example of FIG. 1, the photonic crystal material 12 may have an inverse opal structure, in which the photonic crystal material 12 may have an ordered three-dimensional periodic array of voids defined in a matrix (e.g., a polymer matrix). In such an example, the initial reflectance peak in the reflectance spectrum may arise due to the refractive index contrast (RIC) between the matrix constituent(s) and air in the voids.

Any suitable photonic crystal material may be used in the disclosed devices. For example, some PCs may have open porosity, such that they are comprised of one or more materials permeated with voids. These voids may themselves be ordered, or may be distributed in a disordered fashion throughout one or more of the materials in the PC. In some examples, when a porous PC is exposed to an infiltrating substance, for example a fluid such as a liquid, the infiltrating substance may infiltrate at least a portion of the porous regions in the PC and concomitantly may influence position, shape, and/or intensity of the characteristic reflection, for example due to influence(s) on the refractive index contrast within the PC (Stein et al. Adv. Mater., 13:26, 2001; Miguez et al. Langmuir, 24:4430, 2008).

In some examples, PCs that are non-porous may also be responsive to migration of infiltrating substances, such as fluids, for example through swelling or expansion of one or more components of the PC when such substances migrate into the PC. In some examples, a PC may be porous as well as expandable.

In some examples, the photonic crystal material may itself exhibit responsive behavior to a stimulus apart from response to infiltration by the infiltrating component. For example, an example device may include a photonic crystal material that is responsive to a mechanical compression (e.g., as described in U.S. patent application publication no. 2010/0150511) and an infiltrating component that migrates into or out of the photonic crystal material above a threshold temperature, thus resulting in a device that is responsive to both thermal and mechanical stimuli. Other such combinations of infiltrating response and photonic crystal material inherent response may be possible.

In some examples, the photonic crystal material may be based on an ordered array of first constituents, such as substantially spherical constituents. Examples of suitable first constituents (which may be substantially spherical) for use in an ordered array include metal oxides (such as silica, titania, zinc oxide, tin oxide, aluminum oxide, etc.) and/or polymers. A second constituent may then be introduced into the void spaces within the ordered array of the first constituents. In some examples, the first constituents may be removed (for example by dissolution, chemical etching, or any other suitable method) to provide a photonic crystal material having what may be referred to as an inverse opal structure.

In some examples, where the photonic crystal material includes a polymer matrix, the photonic crystal material may include one or more of: polystyrenes, polymethacrylates, polyacrylates, polyurethanes, polyesters, polyethylenes, polypropylenes, polyamides, polyimides, polycarbonates, fluoropolymers, polyvinylchlorides, polyisoprene, polybutadiene, polydienes, polyolefins, polyethers, polyvinyl acetals, polyvinyl esters, polyvinyl ethers, polyvinyl ketones, polyvinylpyridines, polyvinylpyrrolidones, polyamines, polycations, polyanions, ionomers, polyvinyl alcohols, polyvinyl acids, epoxy resins, silicones, waxes, polysaccharides, cellulosic polymers, polylactides, biopolymers, biodegradable polymers, conducting polymers, redox-polymers, polymers containing metal atoms, and copolymers or combinations thereof. The polymer may be a cross-linked polymer network, for example, to form a polymer matrix. Other conventional polymers may be suitable, including monomers, crosslinkers, polymerization initiators, or other polymer precursors described on the Aldrich Polymer Science page (http://www.sigmaaldrich.com/materials-science/polymer-science.html), or provided by industrial suppliers such as Sartomer.

In some examples, the cross-linked polymer network may include any suitable cross-linked polymers including, for example, cross-linked polymethacrylate and/or cross-linked polyacrylate polymers. The polymer matrix may be formed from a monomer or pre-polymer. Suitable monomers or pre-polymers may include, for example, one or more of: methacrylic acid esters, acrylic acid esters, polyisoprene, polybutadiene, polyurethane precursors, crosslinkable polyethers, and mixtures thereof. In some examples, the methacrylic acid ester may be one or more of: ethylhexyl methacrylate, lauryl methacrylate, butyl methacrylate, methyl methacrylate, stearyl methacrylate, butoxyethyl methacrylate, and mixtures thereof. In some examples, the acrylic acid ester may be one or more of: butoxyethyl acrylate, hydroxyethyl acrylate, 2-carboxyethyl acrylate, stearyl acrylate, lauryl acrylate, butyl acrylate, hexyl acrylate, and mixtures thereof. In some examples, the crosslinkable polyether may be one or more of: polyether diacrylates, polyether acrylates, polyether dimethacrylates, polypropylene glycol diacrylates, polypropylene glycol dimethacrylates, polypropylene glycol acrylates, polypropylene glycol methacrylates, polyethylene glycol diacrylates, polyethylene glycol dimethacrylates, polyethylene glycol acrylates, polyethylene glycol methacrylates, oligoethylene glycol diacrylates, oligoethylene glycol dimethacrylates, oligoethylene glycol acrylates, oligoethylene glycol methacrylates, oligopropylene glycol diacrylates, oligopropylene glycol dimethacrylates, oligopropylene glycol acrylates, oligopropylene glycol methacrylates and mixtures thereof.

In some examples, the polymer matrix may be formed from a monomer or pre-polymer selected from one or more of: methacrylic acid esters, acrylic acid esters, polyisoprene, polybutadiene, polyurethane precursors, polyolefin precursors, polyethers, and mixtures thereof. In some examples, the polymer matrix may be formed from the polymerization of monofunctional acrylic acid esters or multifunctional acrylic acid esters. In some examples, the monofunctional acrylic acid ester may be one or more of: butoxyethyl acrylate, hydroxyethyl acrylate, 2-carboxyethyl acrylate, poly(2-carboxyethyl)acrylate, stearyl acrylate, lauryl acrylate, butyl acrylate, hexyl acrylate, 2-phenoxyethyl acrylate and mixtures thereof. In some examples, the multifunctional acrylic acid ester may be one or more of: diacrylates, triacrylates, polyacrylates, and mixtures thereof. In some examples, the diacrylate may be one or more of: ethylene glycol diacrylate, poly(ethylene glycol)diacrylates, neopentyl glycol diacrylate, neopentyl glycol propoxylate (1 PO/OH) diacrylate, and mixtures thereof.

In some examples, formation of the polymer matrix may be facilitated by a polymerization initiator. An example of a suitable polymerization initiator may be a free radical initiator which may polymerize vinyl, acrylate, thiol, unsaturated, or methacrylate functional monomers. In some examples, the polymerization initiator may be a cationic initiator, which may polymerize epoxide and vinyl ether functional monomers. In some examples, the initiator may be activated by UV light, for example where the initiator includes a photoinitiator; or may be activated by heat, for example where the initiator includes a thermal initiator.

In some examples, the photonic crystal material may have a one-dimensional periodicity, for example having a Bragg stack structure. In such examples, the photonic crystal material may have alternating layers of materials having a refractive index contrast. One or more of these layers may include voids that may be infiltrated by the infiltrating component.

One or more layers may be comprised of nanoparticles or microparticles, for example one or more of: metal nanoparticles, polymer nanoparticles, inorganic nanoparticles, semiconductor nanoparticles, silica, titanium oxide, polymers, graphite, diamond, amorphous forms of carbon, carbon fullerenes, graphenes, carbon nanotubes, silicon, silicon carbide, germanium, simple and complex binary, ternary and quaternary metal oxides, metal chalcogenides, metal borides, metal phosphides, metal silicides, metal carbides, metal nitrides, iron oxides, tin oxides, antimony doped tin oxides, zinc oxides, and combinations thereof. In some examples, one or more layers may be made of a polymer material, for example one or more of: polystyrenes, polymethacrylates, polyacrylates, polyurethanes, polyesters, polyethylenes, polypropylenes, polyamides, polyimides, polycarbonates, fluoropolymers, polyvinylchlorides, polyisoprene, polybutadiene, polydienes, polyolefins, polyethers, polyvinyl acetals, polyvinyl esters, polyvinyl ethers, polyvinyl ketones, polyvinylpyridines, polyvinylpyrrolidones, polyamines, polycations, polyanions, ionomers, polyvinyl alcohols, polyvinyl acids, epoxy resins, silicones, waxes, polysaccharides, cellulosic polymers, polylactides, biopolymers, biodegradable polymers, conducting polymers, redox-polymers, polymers containing metal atoms, and copolymers or combinations thereof. The polymer may be a cross-linked polymer network, for example, to form a polymer matrix. Other conventional polymers may be suitable, including monomers, crosslinkers, polymerization initiators, or other polymer precursors described on the Aldrich Polymer Science page (http://www.sigmaaldrich.com/materials-science/polymer-science.html), or provided by industrial suppliers such as Sartomer.

The infiltrating component 14 may be any suitable substance(s) that may migrate into or out of at least a portion of the photonic crystal material 12 in response to an external stimulus. For example, the infiltrating component 14 may be a solid or a liquid, and may be caused to migrate into or out of the photonic crystal material 12 as described below. Although the example of FIG. 1 shows a single infiltrating component 14, the infiltrating component 14 may include one or more different substances. The photonic crystal device may also include more than one infiltrating components 14.

The external stimulus may be any suitable stimulus of interest including, for example, a mechanical stimulus, a chemical stimulus, an electrical stimulus, a thermal stimulus, a light stimulus, a magnetic stimulus, and combinations thereof. The photonic crystal device may be configured to respond to certain levels or thresholds of the external stimulus.

Upon exposure to one or more predetermined external stimuli, at least a portion of the photonic crystal material 12 may be exposed to the infiltrating component(s) 14 of the device. In examples where the photonic crystal material 12 includes voids, the infiltrating component(s) may migrate into or out of at least a portion of the void space in the photonic crystal material 12, thereby changing the refractive index of the infiltrated portion of the photonic crystal material 12 and thereby causing changes in the optical characteristics of the device, which may be optically detectable, for example as a change in visual appearance.

In some examples, the infiltrating component(s), when infiltrated into the photonic crystal material, may cause a change in the dimensions of the photonic crystal material. For example, the infiltrating component(s) may alternatively or additionally be absorbed by at least a portion of at least one constituent comprising the photonic crystal material, thereby causing the expansion of the infiltrated portion through swelling, consequently increasing the lattice spacing of that portion of the photonic crystal material and causing a change in the optical characteristics of the device, which may be visually observable as a change in appearance. Similarly, migration of the infiltrating component(s) out of a portion the photonic crystal material may cause contraction of that portion of the photonic crystal material, decreasing the lattice spacing of that portion and causing a change in the optical characteristics of the device, which may be visually observable as a change in appearance.

In some examples, the infiltrating component(s) may alternatively or additionally influence the photonic crystal material in other ways including, for example: the infiltrating component(s) may dissolve at least a portion of at least one constituent comprising the photonic crystal material, thereby changing lattice spacing and/or refractive indices and/or disrupting the order of the photonic crystal lattice (which may result in a loss in intensity of reflectance and/or an increase in scattering); the infiltrating component(s) may cause a chemical reaction (e.g., by acting as a catalyst or by reacting with one or more constituents of the photonic crystal material) within the photonic crystal material thereby changing lattice spacing and/or refractive indices; the infiltrating component(s) may trigger any other changes, or may effect combinations of changes as described above or any other known changes possible for a photonic crystal material.

In some examples, the changed optical characteristics of the device (e.g., visual appearance) caused by migration of the infiltrating component(s) may be permanent or temporary (e.g., fully or partially reversible).

In some examples, the infiltrating component may be solid at a particular set of conditions (e.g., at relatively low temperatures, such as below the melting point of the infiltrating component), but may become fluid at a different set of conditions (e.g., at temperatures above the melting point of the infiltrating component). Once such set of conditions has been reached, the fluidized component may migrate into the photonic crystal material. For example, the infiltrating component may include a solid which is solid at room temperature, but becomes liquid above a given temperature. An example of a material suitable for such an infiltrating component may be a solid wax, which becomes liquid above a certain melting temperature. In some examples, the infiltrating component may include a solid which becomes fluid upon exposure to another environmental fluid. For example, certain salts may absorb atmospheric moisture to become liquids.

In some examples, the infiltrating component may include a polymer which becomes fluid upon cleavage along the polymer chain. For example, certain polymers (e.g., polylactic acid) may be degraded by bacteria, which may result in the generation of liquid or fluid products that may migrate into the photonic crystal material. Other example infiltrating components may include polymers that are initially solids but may become fluid upon exposure to certain conditions, including, for example, chemical agents (e.g., hydrolysis by acid or base), ultraviolet (UV) light (e.g., UV-induced chain cleavage), heat (e.g., thermal depolymerization of alpha-methyl styrene), or other such materials.

In some examples, the infiltrating component may be a fluid which may be initially in contact with (but not migrate into) the photonic crystal material, but may not affect the photonic crystal material under certain predefined “normal” conditions. For example, the fluid may migrate the photonic crystal material when the device is subjected to mechanical force, such as where pressure is applied, which may force the fluid to migrate into the photonic crystal material, resulting in a change in the optical characteristics of the device.

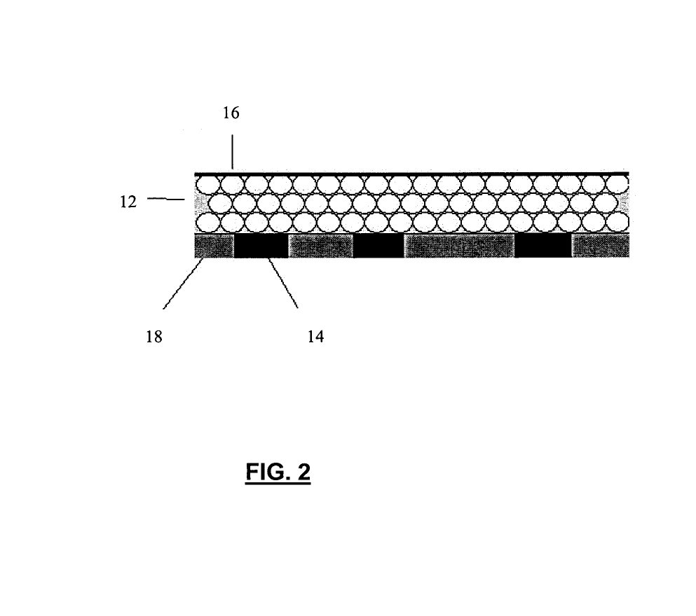

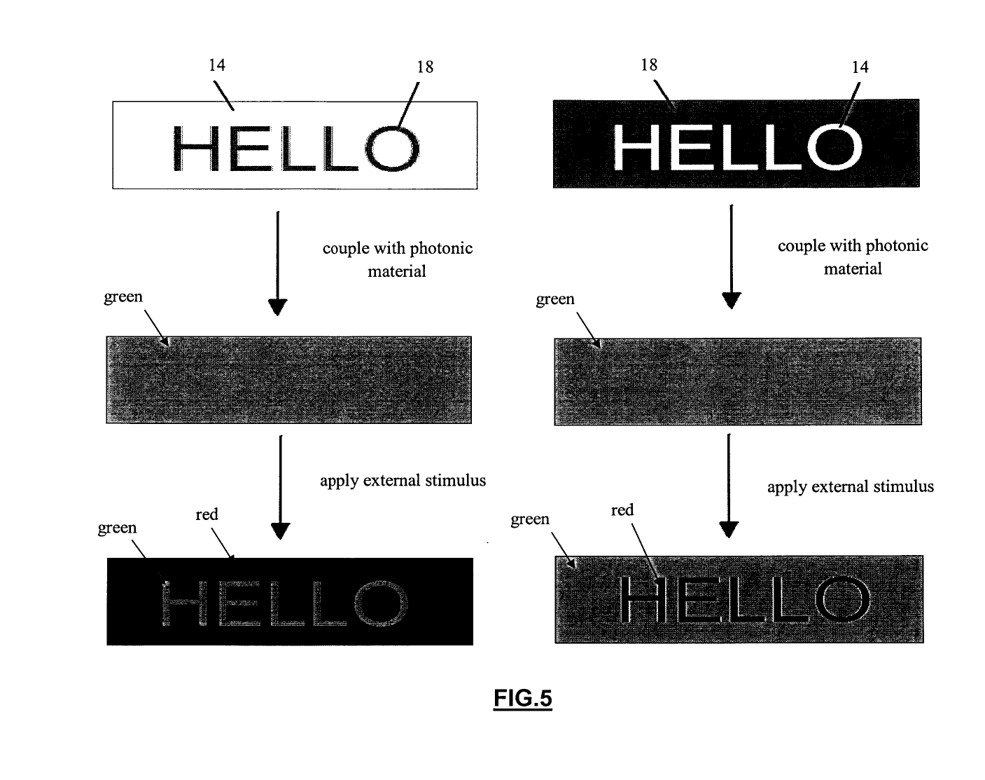

FIG. 2 shows an example photonic crystal device in which predetermined portions of the photonic crystal material 12 may be coupled to the infiltrating component 14 while other portions of the photonic crystal material 12 may be coupled to a non-infiltrating component 18. The use of the non-infiltrating component 18 interspersed with the infiltrating component 14 may allow for encoding of information on the photonic crystal device (for example as will be described with respect to FIG. 5).

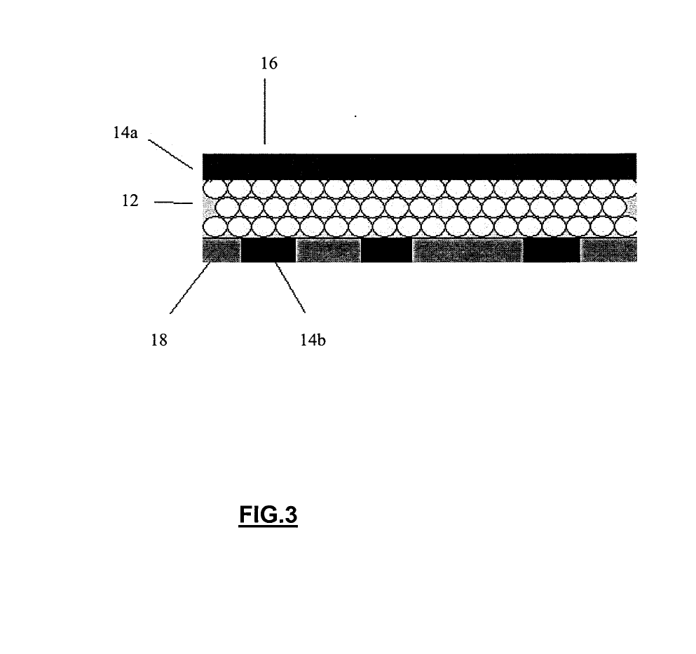

FIG. 3 shows an example photonic crystal device in which there is a plurality of infiltrating components 14a, 14b. In this example, one infiltrating component 14a may be provided over substantially all of the photonic crystal material 12, while a second infiltrating component 14b may be provided over predetermined portions of the photonic crystal material 12, interspersed with a non-infiltrating material 18. In some examples, the first and second infiltrating components 14a, 14b may be responsive to different external stimuli and/or may have different responses to the same external stimulus. For example, the first infiltrating component 14a may be responsive to temperatures above a first threshold while the second infiltrating component 14b may be response to temperatures above a higher second threshold. Thus, the example device may be used to detect if the temperature has remained between the first and second thresholds. In other examples, the first infiltrating component 14a may be responsive to one type of stimulus (e.g., thermal) while the second infiltrating component 14b may be response to a different type of stimulus (e.g., mechanical). Other such variations may be possible, and may be varied for different applications.

Although the first and second infiltrating components 14a, 14b are shown in this example as being provided on opposing surfaces of the photonic crystal material 12, in some examples the first and second infiltrating components 14a, 14b may be provided on the same side of the photonic crystal material 12, either overlapping (i.e., the same portion of the photonic crystal material 12 may be provided with both infiltrating components 14a, 14b) or non-overlapping (i.e., different portions of the photonic crystal material 12 may be provided with different infiltrating components 14a, 14b). In some examples, more than two infiltrating components 14 may be included in the device.

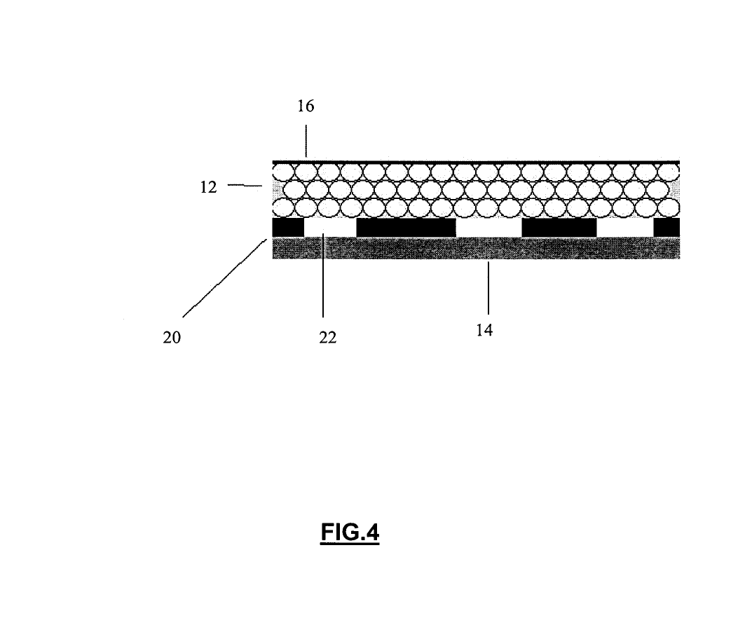

Reference is now made to FIG. 4, which shows an example photonic crystal device having a spacer 20 separating the infiltrating component 14 and the photonic crystal material 12.

In some examples, the infiltrating component 14 may be a fluid which may be physically separated from the photonic crystal material 12 until a certain set of conditions is met. For example, the infiltrating component 14 may be separated from the photonic crystal material 12 by a spacer 20. The spacer 20 may prevent contact between the infiltrating component 14 and the photonic crystal material 12 until the predetermined condition(s) are met. The predetermined condition(s) may include, for example, application of mechanical stimulus (e.g., to cause mechanical deformation such as compression, shear, stretching, etc.), a change in temperature, a passage of time, a presence of one or more chemicals, vapors, liquids, etc.

In some examples, the spacer 20 may separate the photonic crystal material from the infiltrating component 14, and its structural integrity may be reduced by activation by a stimulus. Such a spacer 20 may be, for example, a polymer which may lose structural integrity, for example by becoming fluid or otherwise degraded in response to a stimulus (e.g., melting in response to a thermal stimulus, dissolving in response to a chemical stimulus, etc.). Such a spacer 20 may be frangible, for example, such that it may lose structural integrity when a mechanical stimulus (e.g., mechanical manipulation) fractures the spacer 20, thereby allowing the infiltrating component 14 to contact the photonic crystal material 12. In other examples, the spacer 20 may lose structural integrity by dissolving, melting, collapsing, etc. and thus allow the infiltrating component 14 to contact the photonic crystal material 12.

In some examples, the spacer 20 may include one or more air gaps 22 which may keep the photonic crystal material 12 and infiltrating component 14 separated until, for example, mechanical compression causes the infiltrating component 14 to be pressed through the air gap(s) 22 to contact and migrate into the photonic crystal material 12. In some examples, the spacer 20 may be a solid layer which may prevent contact of the photonic crystal material 12 with the infiltrating component 14, and this spacer 20 may itself be sensitive to the predetermined condition(s). For example, the spacer 20 may deteriorate at the predetermined condition(s), allowing the infiltrating component 14 to contact and migrate into the photonic crystal material 12.

In some examples, the spacer 20 may include a porous or semi-porous layer which may have a changeable permeability to the infiltrating component 14. In this manner, the spacer 20 may function as an openable and closeable “gate”. For example, the spacer 20 may be porous or semi-porous and its permeability to the infiltrating component 14 may be dependent on the hydrophilicity or wettability of a constituent of the spacer 20. For example, the spacer 20 may include a constituent having a phase transition such that it switched from substantially non-wettable (e.g., hydrophobic), and thus impermeable to a water-based infiltrating component 14, to substantially wettable (e.g., hydrophilic), and thus permeable to a water-based infiltrating component 14, when an activation stimulus is applied to the device, with the result that when the activation stimulus is applied, the spacer 20 becomes wettable and the water-based infiltrating component 14 may permeate the spacer 20 and migrate into the photonic crystal material 12.

For example, the spacer 20 may include a porous layer made of a polymer, such as poly(N-isopropyl acrylamide), which is hydrophilic at room temperature, but which becomes hydrophobic when the temperature is raised to above about 35 degrees Celsius. Such a spacer 20 may be incorporated into a device that is responsive to temperatures below about 35 degrees Celsius.

In some examples, the spacer 20 may include a polymer exhibiting a change in wettability in response to light stimuli. For example, azobenzene-modified polymers may show photoswitchable wettability (e.g., as described in N. Delorme, et al., Langmuir, 2005, 21(26), 12278-12282). Other materials exhibiting switchable wettability (e.g., in response to light stimuli or other stimuli), including those known in the art, may be used for the spacer 20.

Other example spacers 20 may include other materials in a porous or semi-porous layer. In some examples, the spacer 20 may include a plurality of such porous or semi-porous layers, with each porous or semi-porous layer being activated to different stimuli, such that the spacer 20 is permeable to the infiltrating component 14 only when the appropriate stimuli or range of stimuli is achieved. For example, a spacer 20 may include a first porous layer made of a first constituent that is hydrophilic only at temperatures above a first temperature T1 and a second porous layer made of a second constituent that is hydrophilic only at temperatures below a second temperature T2, with the result that the spacer 20 is permeable to a water-based infiltrating component 14 only at temperatures that are greater than T1 but lower than T2. In some examples, the spacer 20 may additionally or alternatively include porous or semi-porous layer(s) made of constituents that exhibit changes in wettability in response to various types of stimuli such as, for example, thermal stimuli, radiation stimuli, chemical stimuli, electrical stimuli, or light stimuli, among others.

In some examples, the infiltrating component may exhibit changes in its wettability in response to a stimulus. For example, the infiltrating component may include a polymer constituent (e.g., polymer particles dispersed in a fluid infiltrating component, or a fluid polymer) that may switch its wetting properties in response to a thermal stimulus (e.g., a temperature change). Below a threshold temperature, the infiltrating component may be hydrophilic, and above the threshold temperature, it may be hydrophobic (or vice versa). This change may cause the infiltrating component to flow in or out of a hydrophobic or hydrophilic photonic crystal material or spacer, thereby changing the observed optical effect in response to a stimulus. Other suitable constituents may have changes in wetting properties in response to other types of stimuli.

In some examples, the infiltrating component may be present in the device as capsules or droplets, which may or may not be separated from one another. These capsules or droplets may be initially surrounded by a wall or matrix material which may be ruptured under predetermined condition(s). For instance, application of a mechanical force on the device may cause the wall material to rupture, thereby releasing the infiltrating component which may then contact and migrate into the photonic crystal material.

For example, if the infiltrating component included capsules filled with water, freezing the device may cause the water to expand and fracture the walls of the capsules. Upon thawing the device, the frozen water would liquefy, escape from the now-fractured capsule walls and may contact and migrate into the photonic crystal material, cause an optical change. In some examples, aqueous solutions may be used instead of water, which may allow the activation point (e.g., the threshold temperature at which activation occurs) of the device to be varied. For example, using a water solution of sodium chloride may allow the thaw point to be varied between 0 and −10 degrees Celsius, with the result that the device may response to a threshold temperature between 0 and −10 degrees Celsius. Examples of such a device may be useful as an indicator for indicating the thawing of items that should be kept frozen, such as frozen foods, or for indicating that the temperature has risen above the freezing point of water. In some examples, such embodiments of the device may be manufactured and shipped at ambient conditions, which may result in relatively large savings in cost. Only after the device is applied to the target article and the article (with the device attached) is cooled to below the threshold temperature of the device would the device become responsive to temperatures above the threshold temperature.

In some examples, the infiltrating component may be provided interspersed with the photonic crystal material, but be initially not infiltrated into the photonic crystal material. For example, the photonic crystal material may be provided as flakes or particles (e.g., as described in PCT Publication Number WO 2010/009558) or in segments. The infiltrating component, in a non-infiltrating phase (e.g., as a solid or in a hydrophobic phase) may be interspersed among the photonic crystal material flakes, particles or segments.

For example, photonic crystal flakes may be interspersed with a wax-based infiltrating component and this mixture may be printed on a substrate as an ink (e.g., using suitable printing techniques, such as pad-printing). Initially, the wax-based infiltrating component may be a solid (e.g., at temperatures below its respective melting point). When subjected to a thermal stimulus (e.g., temperatures above its melting point), the infiltrating component may become liquid and thus migrate into the photonic crystal flakes, resulting in a change in the optical effect of the device.

In another example, segments of the photonic crystal material may be provided on a substrate interspersed with the infiltrating component, for example in alternating rows. Initially, the infiltrating component may be in a non-infiltrating phase (e.g., a solid phase or a hydrophobic phase). When subjected to an appropriate stimulus (e.g., a thermal stimulus), the infiltrating component may change to its infiltrating phase (e.g., a liquid phase or a hydrophilic phase) and migrate into the photonic crystal material, resulting in a change in the optical effect of the device.

In some examples, the photonic crystal material may comprise one or more constituents that might change their respective wetting properties in response to a stimulus. For example, a polymer constituent may switch its wetting properties in response to a thermal stimulus (e.g., a temperature change). For example, poly(N-isopropylacrylamide) has a phase transition at 34 degrees Celsius. Below this temperature, it is hydrophilic, and above this temperature it is hydrophobic. This change in phase may cause a fluid (e.g. water or an aqueous solution) to migrate in or out of the photonic crystal material, thereby changing the observed optical effect in response to a stimulus. Other suitable constituents may have changes in wetting properties in response to other types of stimuli.

Although examples of the disclosed device have been described as having an initial state in which the infiltrating component has not infiltrated into the photonic crystal material, and in which infiltration of the infiltrating component into the photonic crystal material is in response to a stimulus, in some examples the disclosed device may have an initial state in which the infiltrating component is already infiltrated into the photonic crystal material.

For example, the infiltrating component may be initially infiltrated into the photonic crystal material (e.g., into the voids of a porous photonic crystal material) in a solid phase. This may be due to, for example, intentional introduction of the infiltrating component into the photonic crystal material during manufacturing. In response to a stimulus (e.g., a thermal stimulus above the melting point of the infiltrating component) the infiltrating component may change to a fluid phase and may migrate out of the photonic crystal material, resulting in a change in the optical effect of the device. The migration of the fluid phase infiltrating component out of the photonic crystal material may be due to, for example, hydrophobicity of the photonic crystal material, the presence of an absorptive, porous, or more highly wettable layer adjacent to the photonic crystal material, repulsion between the infiltrating component and the photonic crystal material, or any other suitable phenomenon.

In another example, the hydrophilicity of the photonic crystal material, the spacer and/or the infiltrating component may change in response to a stimulus. For example, in the initial state, the device may include a water-based infiltrating component already infiltrated into a photonic crystal material in a hydrophilic phase. In response to a stimulus (e.g., a thermal stimulus, such as described above), the photonic crystal material may change to a hydrophobic phase, thus repelling the water-based infiltrating component and causing the migration of the infiltrating component out of the photonic crystal material, resulting in a change in the optical effect of the device. In another example, in the initial state, the device may include a water-based infiltrating component already infiltrated into a photonic crystal material, and a hydrophobic spacer. In response to a stimulus (e.g., a thermal stimulus), the spacer may change to a hydrophilic phase, thus attracting the water-based infiltrating component out of the photonic crystal material, resulting in a change in the optical effect of the device. Other such variations may be possible.

In some examples, the disclosed device may be partially or fully reversible. For example, the second optical effect may revert back to the first optical effect over time (e.g., at a certain reversal rate), as the infiltrating component either exits the photonic crystal material (e.g., due to a repulsion between the infiltrating component and the photonic crystal material) or as the infiltration component leaves the device (e.g., via evaporation or dewetting). In some examples, the reversibility of the device may be assisted by a dewetting layer (e.g., an absorptive, porous, or more highly wettable layer), such as a liquid-absorbing or liquid-wicking layer adjacent to the photonic crystal material that assists in removing infiltrated liquid from the photonic crystal material.

In some examples, the reversibility may be controlled by controlling the stimulus. For example, where migration of the infiltrating component is caused by a change in wettability in response to a stimulus (e.g., the photonic crystal material may become hydrophilic when temperatures drop below a threshold temperature, such that the infiltrating component migrates into the photonic crystal material at temperatures below the threshold temperature), removal of the stimulus or application of an opposing stimulus may reverse the migration of the infiltrating component (e.g., the photonic crystal material may revert to a hydrophobic phase when temperatures are raised above the threshold temperature, such that the infiltrating component migrates out of the photonic crystal material above the threshold temperature).

The rate at which this reversal process occurs may be related to the property of the photonic crystal material and/or of the infiltrating component. In some examples, the reversal rate may also be affected by one or more external stimuli such as air pressure, mechanical stress or strain, temperature, or water vapor. In some examples, the reversal may be prevented or slowed by some external stimuli. In some examples, the reversal may be partial, wherein the device does not fully revert back to the first optical effect. For example, the device may revert only partially to a third optical effect that is intermediate between the first and second optical effects, and which may be detectably different from the first and second optical effects.

In some examples, the device may be repeatedly reversible, while in other examples the reversibility of the device may be limited. For example, where reversion back to the first optical effect is due to the infiltrating component being removed from the device (e.g., via evaporation), the device may no longer be responsive to stimuli, due to the absence of any infiltrating component remaining in the device.

In some examples, the changes in optical properties of the photonic crystal material may include a change in the characteristic reflection, including a change in terms of peak position, shape, width and/or height, among others. If absorption of the infiltrating component results in a decrease in the refractive index contrast of the photonic crystal material (e.g., the refractive indices of the constituents of the photonic crystal material may become similar), the reflectance peak of the photonic crystal material may be reduced and transmissivity may be increased (which may be observed as an increase in the transmittance spectrum of the photonic crystal material), resulting in a transparent, translucent, or substantially colorless appearance of the device. In some examples, the device may include a background or underlying image (e.g., on a background layer), such that when the reflectance peak of the photonic crystal material is decreased, rather than the entire device becoming transparent, the background or underlying image included in the device may be revealed.

In some examples, the photonic crystal material in the disclosed device may contain voids. In some examples, such voids may form an ordered array (e.g., where the photonic crystal material has an inverse opal structure). In some examples, one or more of the constituents of the photonic crystal material may be permeated with pores which may be ordered or disordered (e.g., where the photonic crystal material is a Bragg Stack having one or more porous layers). In some examples, the voids may be closed cells (i.e., disconnected voids), may be open cells (i.e., connected voids), or may be a combination thereof.

In some examples, the infiltrating component may include one or more suitable solvents, polymers, oligomers, natural and synthetic oils, petroleum derivatives, aqueous fluids, sugars, and fused salts (including ionic liquids), among others. In some examples, the infiltrating component may include one or more suitable “fluidizable” solids, such as polymers, natural and synthetic waxes and gums, sugars, organic molecular solids, salts, and oligomers, among others. In some examples, the infiltrating component may also include a vapor or gas, for example such that this vapor or gas may condense into the photonic crystal material as a liquid or solid.

In some examples, the device may be provided with encoded information. For example, information may be encoded in the device by providing the infiltrating component and/or the spacer in a predetermined configuration, and/or by configuring the device such that a given stimulus would preferentially act on certain predetermined areas. For example, the device may be provided on a surface with selectively raised portions, such that mechanical compression of the device against the surface would selectively cause the infiltrating component to be pushed into the photonic crystal material in those selectively raised portions. The response of example devices with this encoding may result in designs, indicia, graphics, logos, data, etc. to become visible, invisible, to change color, to go from colored to colorless, or otherwise become optically detectable.

In some examples, information may be encoded into the device by other suitable methods. For example, the photonic crystal material may be impregnated with additives that may affect the response of the photonic crystal material. For example, where the device is designed to be responsive to mechanical compression, certain portions of the photonic crystal material may have embedded additives that prevent infiltration by the infiltrating component (e.g., portions of the photonic crystal material may have liquid-repelling additives, or a patterned barrier coating/membrane), such that those portions retain the initial reflection spectrum while other portions exhibit a shift in reflection spectrum, thus revealing the encoded information. Alternatively or additionally, certain portions of the photonic crystal material may include embedded additives that may promote infiltration by the infiltrating component, such that those portions exhibit a greater change in the reflection spectrum. An example of such an additive may be a surfactant, which may help to promote greater wetting (and hence greater infiltration into those portions of the photonic crystal material having the additive) by the infiltrating component.

In some examples, the device may include a background layer which is concealed by the photonic crystal material in its initial state (e.g., exhibiting reflectance wavelengths in the visible spectrum) but is revealed when the reflectance of the photonic crystal material shifts in response to an external stimulus (e.g., the reflectance peak shifts outside of the visible spectrum and/or the reflectance peak of the reflectance spectrum is decreased, causing the photonic crystal material to appear transparent and revealing the background layer underneath, or vice versa).

In some examples of the device, the infiltrating component may be provided only over predetermined portions of the photonic crystal material. For example, in FIG. 5A, an example device may have the infiltrating component 14 over substantially all of the photonic crystal material 12, with the exception of certain portions that are instead provided with a non-infiltrating material 18, in this example creating the encoded message “HELLO”. Conversely, in FIG. 5B, an example device may have the infiltrating component 14 over predetermined portions of to spell out the encoded message “HELLO” while the remaining areas are provided with the non-infiltrating material 18. In both examples, when the photonic crystal material 12 overlaid on top, the encoded information is hidden since the photonic crystal material 12 has a relatively uniform reflectance spectrum over its entire area (in this example, a reflectance in the “green” wavelength range). When an external stimulus is applied (e.g., heat), the infiltrating component 14 is caused to migrate into corresponding portions of the photonic crystal material 12, causing the reflectance spectrum of the infiltrated portions to change, in this example to a reflectance in the “red” wavelength range. In the example of FIG. 5A, applying the external stimulus results in a background that appears red while the portion corresponding to the non-infiltrating component 18 remains green, thus revealing the message “HELLO”. Conversely, in the example of FIG. 5B, applying the external stimulus results in a background that remains green, while the portion corresponding to the infiltrating component 14 changes to red, revealing the message “HELLO”.

Other variations may be used to encode information in the photonic crystal device. In some examples, a patterned stimulus could be intentionally applied to the device in order to generate a desired design, indicia, graphic, logo, datum, etc. For instance, information can be encoded into the photonic crystal device by hot stamping or imprinting onto a device having a solid component which fluidizes upon contact with the stamped areas.

Although the above examples describe encoded information that is revealed when the device responds to an external stimulus, in some examples the device may encode information that is hidden when the device responds to an external stimulus. For example, the photonic crystal material may appear initially transparent (e.g., having a reflectance spectrum outside the visible spectrum, or having a low reflectance peak and high transmission values in its transmittance spectrum) thus revealing information on an underlying background layer, and may respond to an external stimulus to become visible (e.g., shifting to a reflectance spectrum in the visible spectrum, or increasing in its reflectance peak and decreasing in its transmittance spectrum) thus concealing the underlying background layer.

In some examples, the device may include one or more additional layers including, for example, a substrate layer, an adhesive layer, a release layer, a protective layer, and a background layer, among others.

For example, a substrate layer may be provided (e.g., opposite to a top or viewing surface of the device) for rigidity, robustness and/or ease of handling. In some examples, the photonic crystal device may be suitable rigid and/or robust without requiring a substrate layer, for example where the photonic crystal material and/or the infiltrating component is sufficiently thick or is itself relatively rigid. The substrate layer may be in contact with the photonic crystal material or the infiltrating layer, depending on the configuration of the layers. In some examples, the photonic crystal material or the infiltrating component may be manufactured directly on the substrate layer. In other examples, the photonic crystal material or the infiltrating component may be coupled to the substrate layers as a manufacturing step. Any suitable material may be used for the substrate layer including, for example, plastic foil, film, membrane or sheet (including, for example, reinforced or composite plastics or porous plastics); metal foil, film or sheet; glass, paper, cardboard or other non-woven fibrous materials; natural or synthetic fabrics; ceramics, cermets or other ceramic composites; or any other suitable material, or combinations thereof. The substrate may be suitably thick, rigid, flexible, transparent, etc. depending on the application.

In some examples, an adhesive layer may be provided (e.g., opposite to a top or viewing surface of the device), to allow the device to be applied to an article or surface. Where the device is provided to be adhered to an article or surface, the adhesive layer may be provided with a removable protective cover, to avoid unintentional adherence. In some examples, where the adhesive layer comprises a liquid adhesive, a substrate layer may be used between the adhesive layer and other components of the device, to avoid the adhesive unintentionally infiltrating the photonic crystal material.

In some examples, a release layer may be provided (e.g., over the adhesive layer) to avoid unintentional adhesion of the device. The device may be released from the release layer (e.g., by peeling off the release layer) when it is desired to apply the device to an article.

In some examples, a protective layer may be provided (e.g., on a top or viewing surface of the device) to protect the components of the device from contamination and/or to improve the robustness of the device, for example as described above. Suitable materials for the protective layer may include, for example, glass, polymer or combinations thereof. The protective layer may be selected to be suitably flexible, rigid, thin, etc. depending on the application.

In some examples, a background layer may be provided (e.g., opposite to a top or viewing surface of the device), which may include encoded information that may be revealed or hidden when the device responds to an external stimulus. In some examples, the background layer may also function as a substrate layer.

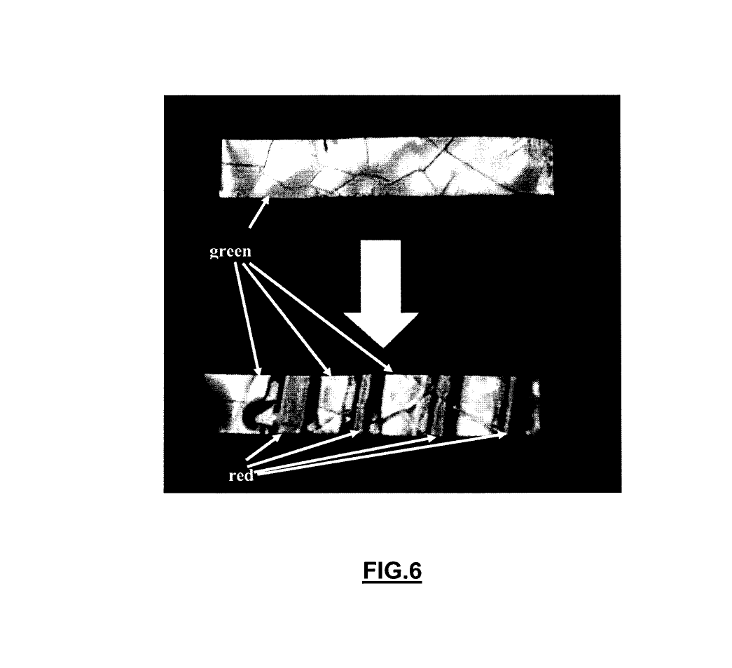

FIG. 6 shows a response of an example photonic crystal device. In this example, the infiltrating component only migrates into certain portions of the photonic crystal material (e.g., the infiltrating component is provided on only portions of the photonic crystal material and migrates into only those portions). The top image shows the example device in its initial state, having a substantially uniform green appearance, for example. When an external stimulus is applied (e.g., heat), the device responds and appears as shown in the bottom image, where portions of the photonic crystal material has been infiltrated by the infiltrating component and appears red, while remaining portions remain green.

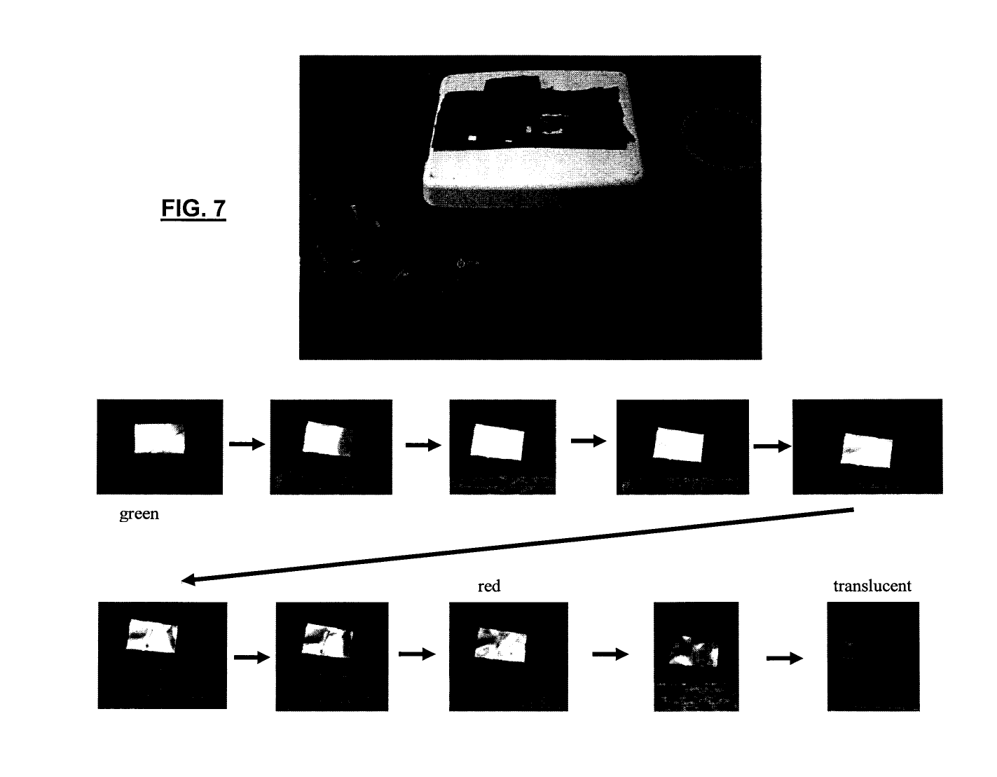

FIG. 7 is a series of images showing the response of an example photonic crystal device to an increasing thermal stimulus (i.e., increasing heat). The example device was placed on a thermal source (e.g., a hot plate) and subjected to increasing temperatures. The top image shows an example setup. As shown in the left-most image, in its initial state, the device has a substantially uniform reflectance spectrum in the green wavelength, giving a substantially uniform green appearance. The arrows indicate increasing heat. When a threshold temperature is exceeded, the reflectance spectrum of the example device responds to the thermal stimulus by shifting to the red wavelength (e.g., due to infiltration of the photonic crystal material by the infiltrating component), resulting in a red appearance. Further increase in temperature may result in the reflectance spectrum shifting outside of the visible wavelengths (e.g., due further infiltration by another infiltrating component) or loss of reflectance properties (e.g., due to degradation or collapse of the periodic structure of the photonic crystal material and/or due to a reduction in the refractive index contrast), resulting in a transparent appearance.

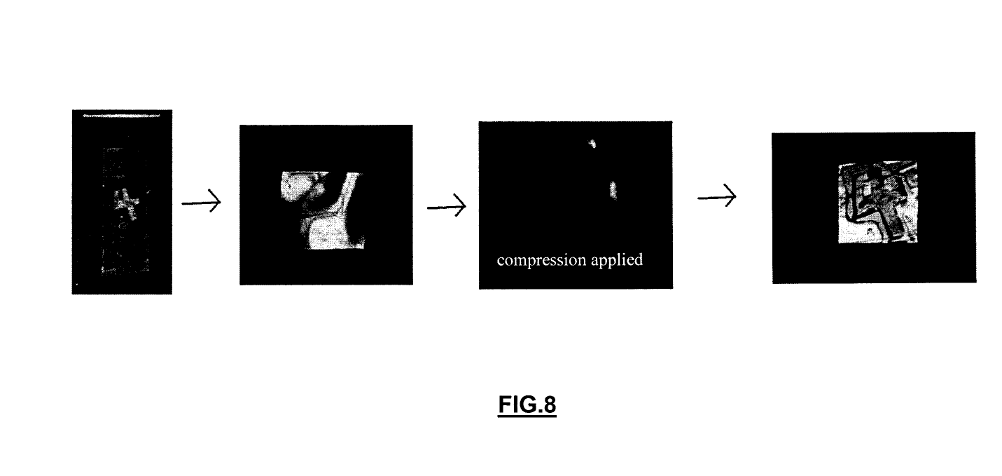

FIG. 8 is a series of images showing the response of an example photonic crystal device to a mechanical stimulus, in this case mechanical compression against a raised pattern. The left-most image shows the raised pattern, a “4”, that the device may be pressed against. In some examples, such a raised pattern may be provided as part of the device, for example as a substrate layer or a background layer. When the device is applied over the raised pattern, the pattern may be hidden and undetectable. When the device is compressed against the raised pattern (e.g., the application of finger pressure by a user), the raised portions of the pattern may cause the infiltrating component to migrate into corresponding portions of the photonic crystal material, resulting in a change in optical effect in those portions. As shown in the right-most image, this may result in the pattern being revealed by the device.

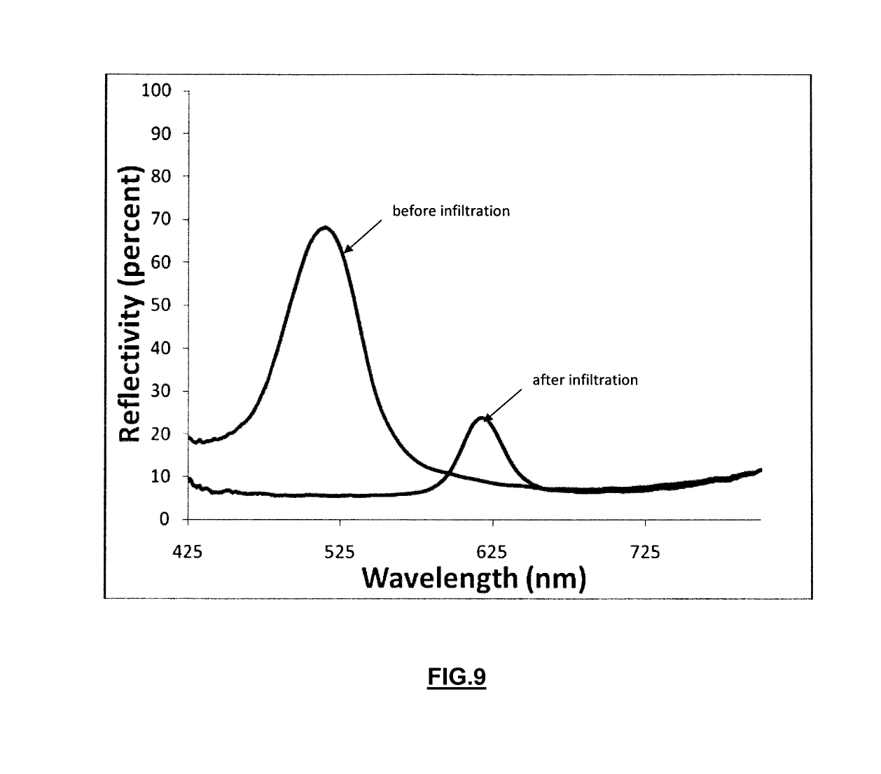

The behavior of example photonic crystal materials upon infiltration are shown in FIGS. 9 to 12. The materials shown in these figures may be suitable for use in the photonic crystal device disclosed herein.

FIG. 9 shows example reflectivity curves of an example polymer inverse opal photonic crystal material before and after infiltration by an infiltrating component. The photonic crystal material exhibiting these curves may be suitable for use in, for example, a photonic crystal device similar to that shown in FIG. 6.

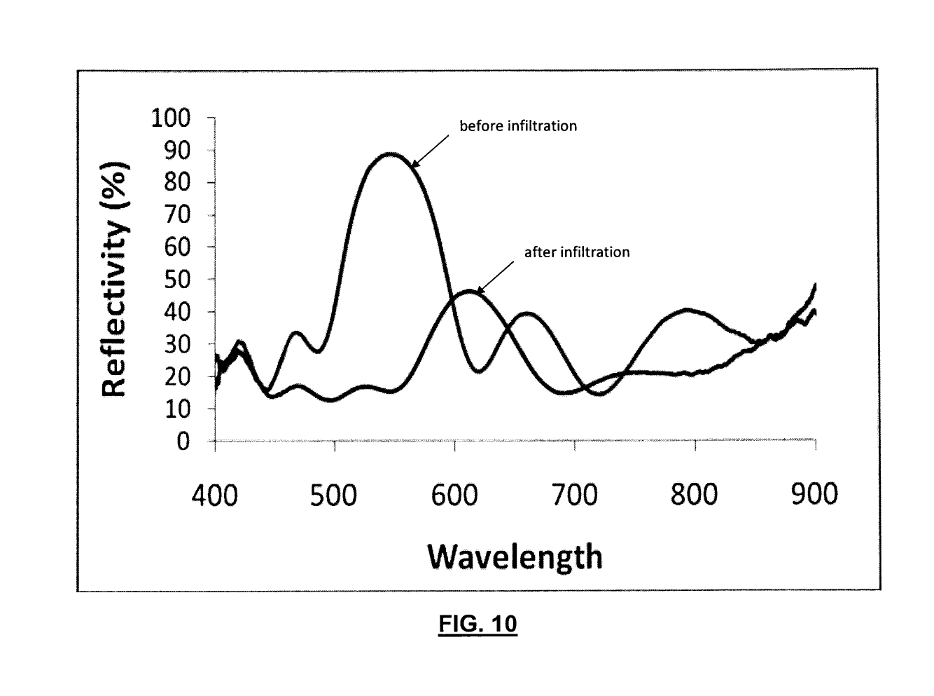

FIG. 10 shows example reflectivity curves of an example silica-titania nanoparticle Bragg Stack photonic crystal material before and after infiltration by an infiltrating component.

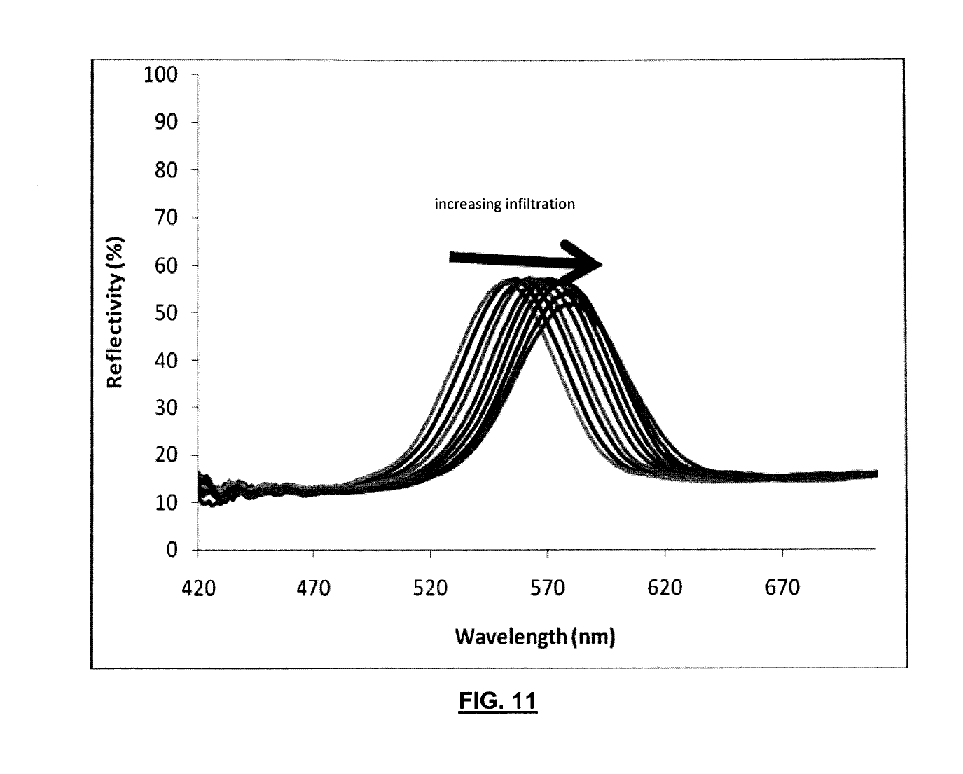

FIG. 11 shows example reflectivity curves of the photonic crystal material used in the example of FIG. 7, and the changes in reflectivity that occur when increasing amounts of the infiltration component permeate into the photonic crystal structure.

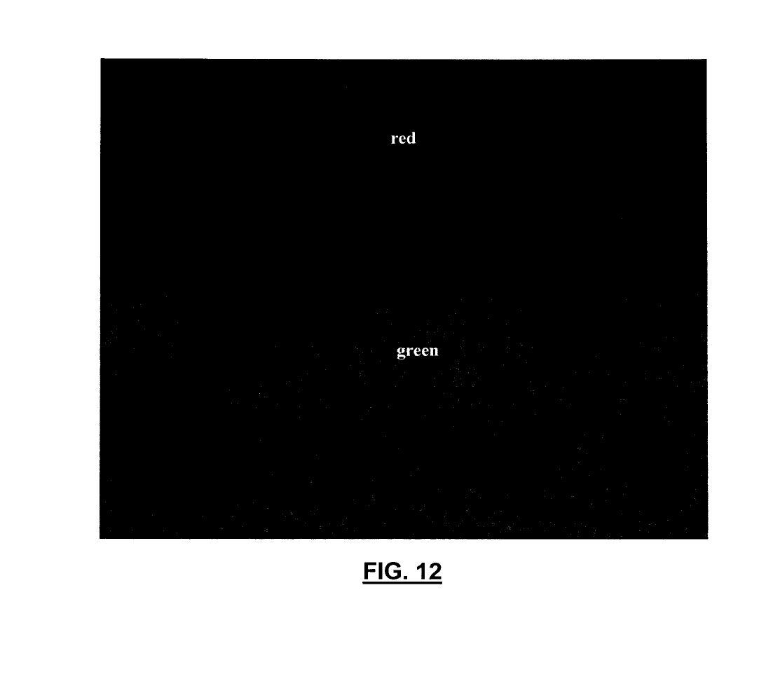

FIG. 12 shows an optical microscope image of an example material where only a selective region of the material has been infiltrated with an infiltrating component. The original material is green (bottom), and becomes red (top) upon infiltration. The view in this image is approximately 200×200 microns.

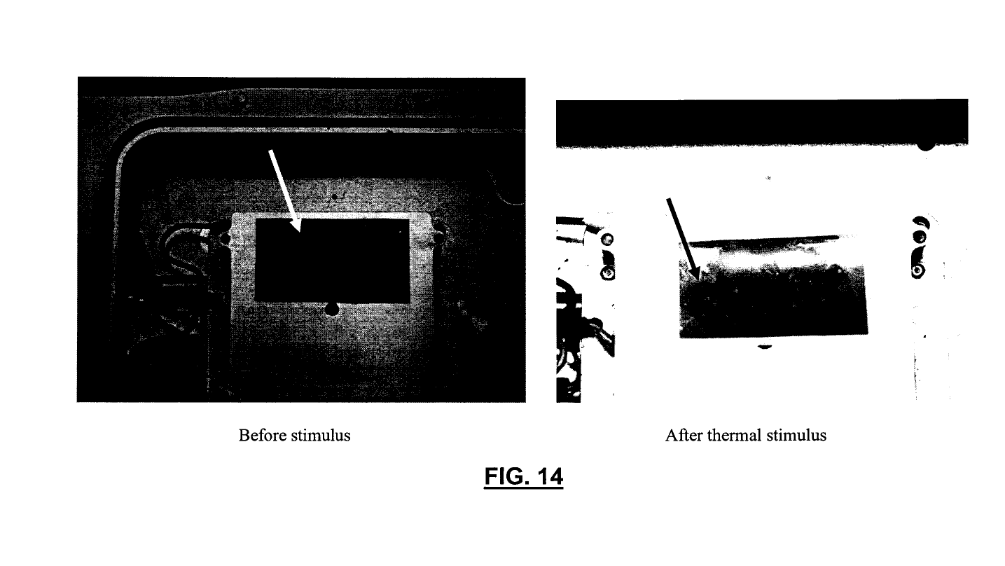

FIG. 14 shows images of an example photonic crystal device before and after application of a stimulus causing activation of the device.

The example device of FIG. 14 was constructed by first providing a film of the photonic crystal material on a substrate (e.g., a Mylar substrate). The photonic crystal material exhibited an initial reflectance spectrum in the red wavelengths. The infiltrating component, in this case a wax layer, was coated on a second substrate (e.g., a Mylar substrate) by melting the wax and coating it onto the substrate using a heated fixed-gap applicator having a 2 MIL gap, then allowing the wax layer to cool and harden. Other methods of forming the wax layer may be suitable. The infiltrating component in this example has a melting point of about 70 to about 80 degrees Celsius, and is conventionally available (e.g., supplied by Aldrich Polymer Science). The photonic crystal material was then laminated onto the wax layer at a temperature slightly below the melting point of the wax (e.g., about 60 to about 65 degrees Celsius). The laminated structure was then coupled (e.g., using a latex glue) to a paper substrate having the graphic “OPENED”.

In operation, when the example device of FIG. 14 is brought above the melting point of the wax layer (e.g., by heating the device to 75 degrees Celsius), the wax layer melts and the molten wax migrates into the photonic crystal material, changing the overall refractive index of the photonic crystal material as well as the refractive index contrast within the photonic crystal, and causing its reflectance spectrum to change from reflecting red wavelengths to appearing substantially transparent, thereby revealing the underlying graphic “OPENED”.

In FIG. 14, the left image shows the device before application of the thermal stimulus, having a substantially uniform red appearance (white arrow). Application of the thermal stimulus resulted in an optical change from the appearance of a red color to transparent, allowing the underlying graphic (“OPENED”) (black arrow) to be detectable upon activation.

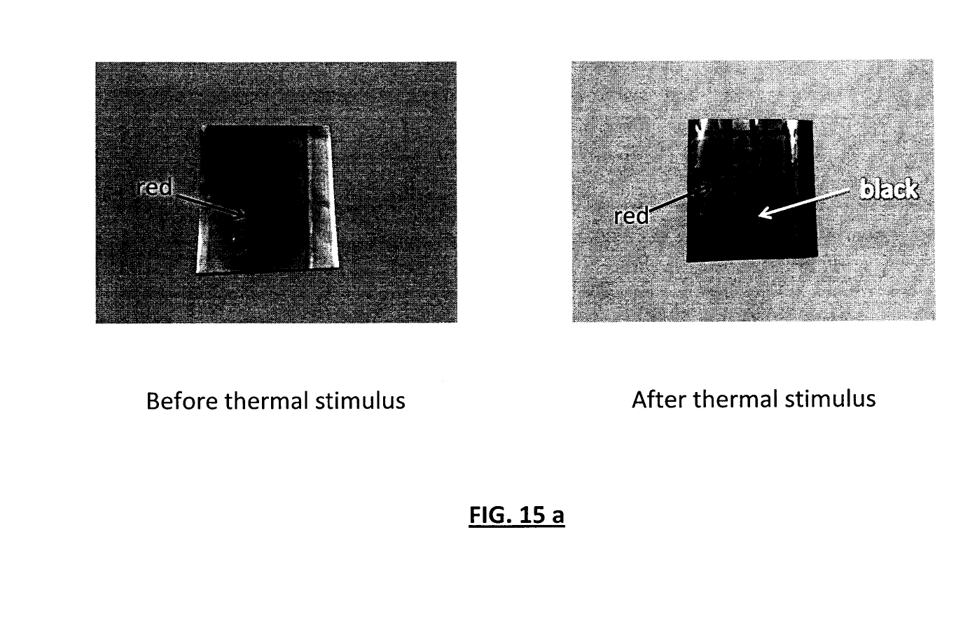

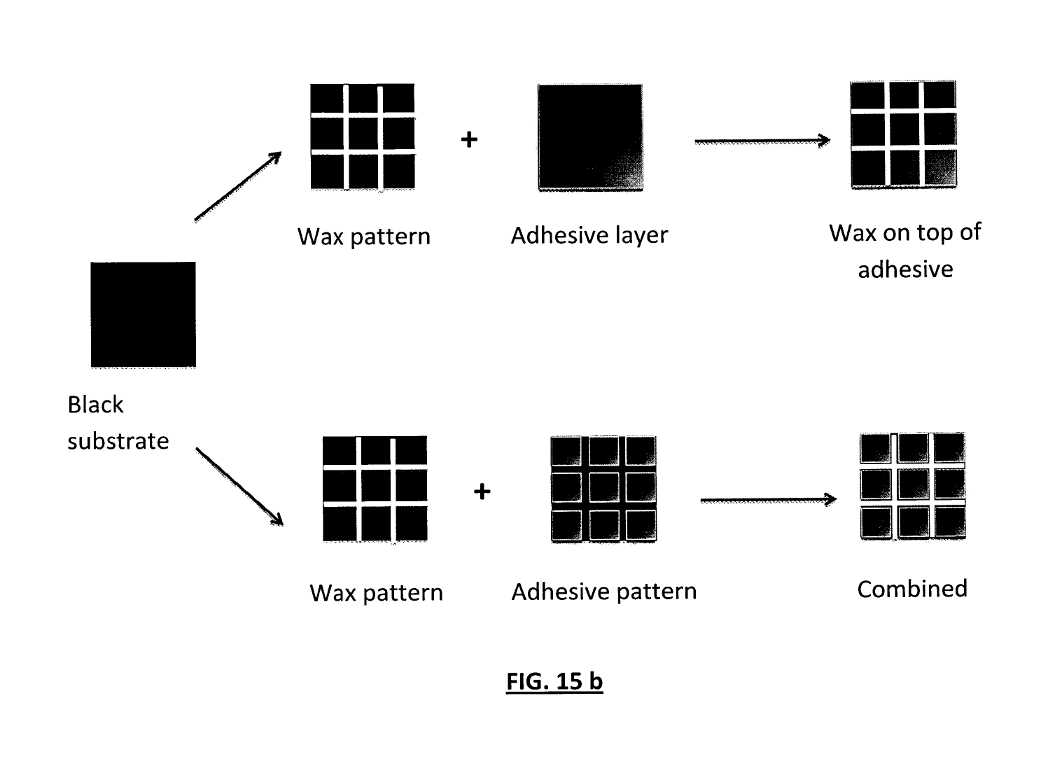

FIG. 15a shows images of another example photonic crystal device before and after application of a stimulus, in this case a thermal stimulus, causing activation of the device.

The example device of FIG. 15a is constructed by first providing a film of a photonic crystal material on a first substrate, in this case a Mylar® substrate about 12 μm thick. The photonic crystal material in this example includes an array of silica beads of approximately 300 nm in diameter, synthesized according to standard techniques (e.g., as described in W. Stober, et al., J. Colloid Inteface Sci. 1968, 26, 62), and assembled into a film that is about 10 μm thick using standard techniques (e.g., an evaporation-induced assembly method as outlined in P. Jiang et al., Chem. Mater. 1999, 11, 2132). The resulting photonic crystal material had periodic refractive index contrast giving rise to an initial red reflection color.

The infiltrating component (in this case a wax with melting point of about 74° C. and a refractive index of about 1.43 at 20° C., commercially available from Aldrich Chemical Company) was coated on a second substrate that has a contrasting color to the photonic crystal material on the first substrate (e.g. a black Mylar substrate about 12 μm thick). The infiltrating component was coated with a predetermined design, in this example a grid pattern. Controlled coating of the infiltrating component, in order to attain a predetermined design or other embedded data, may be achieved by any number of methods of printing a molten wax, such as heated gravure printing, thermal transfer printing, wax ink (phaser) printing, thermojet printing, or by any other suitable methods. The infiltrating component may also be printed using a wax dispersion, emulsion, or solution from an aqueous or organic solvent medium. The molten wax may be coated onto the second substrate in the desired design, then allowed to cool and harden, before being laminated to the photonic crystal material at a temperature slightly lower than the melting point of the wax, for example laminated at about 65° C.

The thickness of the layer of the infiltrating component required to achieve full infiltration of the photonic crystal material was found to be directly proportional to the volume of the voids in the photonic crystal material with which the infiltrating component is in direct contact with. The typical thickness of the wax layer in this example, in order to achieve satisfactory infiltration in response to a thermal stimulus, was about 3-5 μm.

In operation, when the example device of FIG. 15a was brought above the melting point of the wax layer (e.g. by heating the device to above 75° C.), the wax melted and the molten wax migrated into areas of the photonic crystal material with which the wax was in direct contact. Since there was a relatively small difference between the refractive index of the wax and that of the photonic crystal material (in this example, the silica spheres had a refractive index of approximately 1.425 while the wax had a refractive index of about 1.43), the infiltration of the wax into the photonic crystal material reduced the refractive index contrast within infiltrated portions of photonic crystal material, and caused the reflection peak of these portions to change from red reflectance wavelengths to having reduced or no reflectance (i.e., appearing substantially transparent), thereby revealing the underlying contrasting color in of the substrate (i.e. black in this example). Because infiltration of the melted wax was limited to portions of the photonic crystal material in direct contact with the wax, and because the wax was coated in a predetermined grid pattern, this change in optical properties occurred only for those portions of photonic crystal material that were in direct contact with the wax pattern, resulting in the previously unobserved grid pattern appearing in contrasting color upon application of the thermal stimulus.

In FIG. 15a, the left image shows the example device before the application of the thermal stimulus. The device shown is approximately 2 cm×2 cm in area and has a generally uniform red appearance before activation (i.e., application of the stimulus). Application of the thermal stimulus caused an optical change in portion(s) of the device to reveal a contrasting black color in a previously hidden grid pattern.

To ensure intimate contact between the photonic crystal material and the second substrate bearing the infiltrating wax component, an optional thin adhesive layer (e.g. a layer about 1-3 μm thick, with heat-sealed, pressure-sensitive or UV curable adhesives) may be coated as a continuous layer on the second substrate before the wax pattern is applied. Alternatively, as illustrated in FIG. 15b, the adhesive layer may be coated (e.g., with suitable printing techniques) on the second substrate in a complementary pattern to the wax pattern.

Any suitable adhesive may be used for this adhesive layer. For example, the adhesive may be one or more of: acrylic adhesive, methacrylate adhesives, acrylonitrile adhesive, cyanoacrylate adhesive, single-part epoxy adhesive, two-part epoxy adhesive, polyurethane adhesive, polyamide adhesive, polyester adhesive, polyethylene adhesive, polypropylene adhesive, polyimide adhesive, polysulfide adhesives, polyvinyl acetate adhesive, polyvinyl alcohol adhesive, polyvinyl chloride adhesive, polyvinylpyrrolidone adhesive, hot-melt adhesive, UV curable adhesives, contact adhesive, pressure-sensitive adhesive, thermoplastic adhesive, silicone adhesive, anaerobic adhesive, electrically-conductive adhesive, thermally-conductive adhesive, aerosol adhesive, nitrocellulose adhesive, resorcinol adhesive, ethylene-vinyl acetate adhesive, phenol formaldehyde adhesive, styrene block copolymer adhesive, nitrile adhesive, emulsion adhesive, thermoset adhesive and combinations thereof.

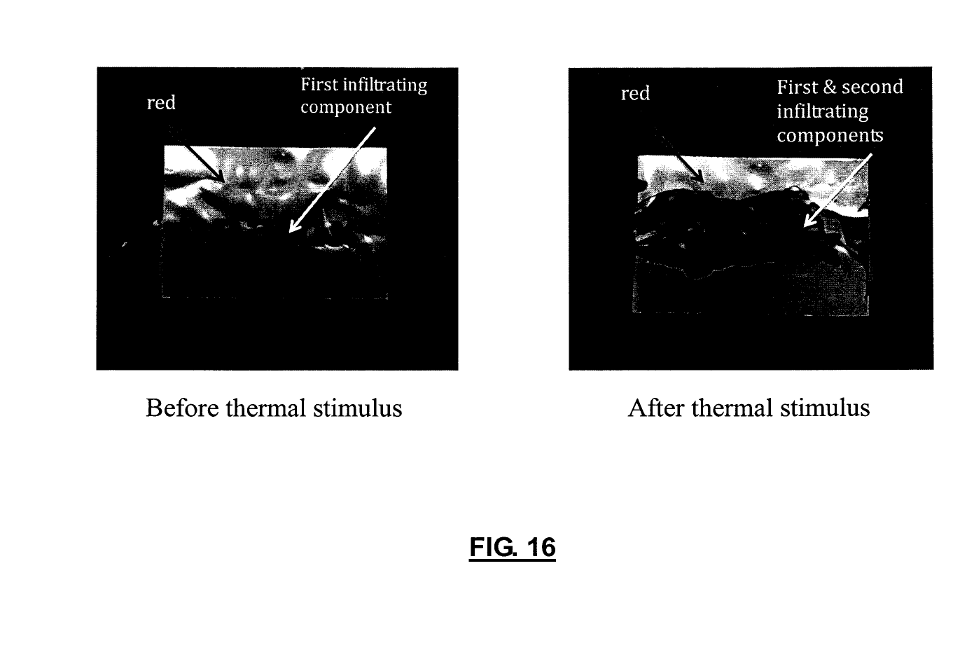

FIG. 16 shows images of another example photonic crystal device before and after application of a thermal stimulus causing activation of the device. The device of this example includes two different infiltrating components.

The example device of FIG. 16 was constructed by first providing a film of the photonic crystal material on a substrate (e.g., a Mylar substrate about 12 μm thick). The photonic crystal material in this example may be similar to the photonic crystal material in the example of FIG. 15a. The photonic crystal material exhibited an initial reflectance spectrum in the red wavelengths.

A first infiltrating component, in this case a commercially available, UV curable screen printing ink (commercially available from Nazdar Ink Technologies), was infiltrated into parts of the photonic crystal material using suitable techniques (e.g., screen-printing). The refractive index contrast of the infiltrated portions of the photonic crystal material was substantially reduced, causing the reflectance spectrum in the infiltrated portions to change from reflecting red wavelengths to having reduced or no reflectance wavelengths (i.e., appearing substantially transparent). This created an overt pattern in the photonic crystal material where the areas infiltrated by the first infiltrating component appeared transparent while the rest of the material maintained a red appearance. The first infiltrating component may be applied to the photonic crystal material in a predetermined design by any suitable printing methods such as gravure printing, pad printing, inkjet printing, and screen-printing, among others. Other methods of controlled coating of the first infiltrating component may also be used. In this example, after the first infiltrating component has infiltrated the portions of the photonic crystal material, UV curing was used to set the first infiltrating component and render it inert to the activating stimulus (in this case a thermal stimulus).

A second infiltrating component, in this case a conventionally available wax with melting point at about 74° C. and refractive index of about 1.43 at 20° C., was coated on a second substrate that has a contrasting color to the photonic color material (e.g. a black Mylar substrate about 12 μm thick) by a applying the molten wax on the substrate with a heated printing method as described in the example of FIG. 15a. The second infiltrating component was coated uniformly over the second substrate. The refractive index of the second infiltrating component was in the same range as that of the first infiltrating component and the silica spheres of the photonic crystal material. The patterned photonic crystal material was then laminated onto the wax layer at a temperature slightly below the melting point of the wax (e.g. about 65° C.), with the second infiltrating component uniformly contacting the area of the photonic crystal material having portions infiltrated by the first infiltrating component.

In operation, when the example device of FIG. 16 was brought above the melting point of the wax layer (e.g. by heating the device to 75° C.), the wax layer melted and the molten wax migrated into portions of the photonic crystal material. This infiltration reduced the refractive index contrast in the infiltrated portions of the photonic crystal material, causing the reflectance spectrum in these portions to change from reflecting red wavelengths to having reduced or no reflectance wavelengths (i.e., appearing substantially transparent). Since the refractive indices of the first and second infiltrating components, as well as that of the silica spheres of the photonic crystal material were similar to each other (in this case all in the 1.40-1.50 range), the refractive index contrast in any infiltrated portion(s) of the photonic crystal material was reduced, rendering these portions of the photonic crystal material substantially transparent, and allowing the contrasting background color of the second substrate to show through. After the infiltration of the second component, the pattern created by the first infiltrating component was no longer observable since the second infiltrating component infiltrated portions of the photonic crystal material that was not infiltrated by the first infiltrating component.

In FIG. 16, the left image shows the device before application of the thermal stimulus, displaying a pattern caused by the first infiltrating component infiltrating predetermined portions of the photonic crystal material and selectively revealing portions of the black substrate. Application of the thermal stimulus melted the second infiltrating component, causing an optical change in the remaining parts of the photonic crystal material from red to transparent, thus removing the visual pattern formed by the first infiltrating component.

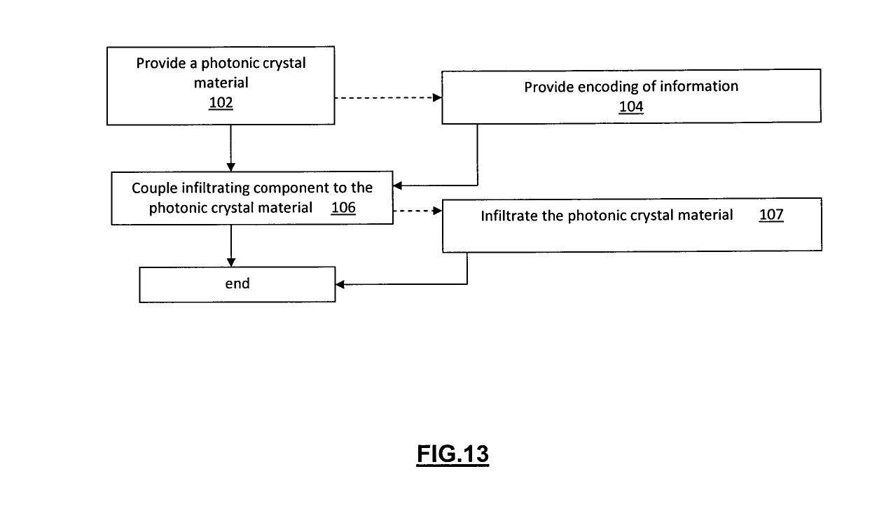

Example methods for manufacturing examples of the disclosed photonic crystal device are now described. An example manufacturing method is shown in FIG. 13.

At 102, a suitable photonic crystal material may be provided. The photonic crystal material may be any suitable one-, two- or three-dimensional photonic crystal material having a reflectance spectrum that is affected by infiltration of an infiltrating component. In some examples, the photonic crystal material may be designed to have an initial reflectance spectrum and/or a response reflectance spectrum in certain wavelength ranges (e.g., certain desired colors), the photonic crystal material may be designed to have mechanical or structural properties (e.g., flexibility, rigidity, thickness, etc.).

In some examples, providing the photonic crystal material may include manufacturing the photonic crystal material using suitable methods. In some examples, the photonic crystal material may be provided with a substrate layer, a background layer, an adhesive layer and/or a protective layer.

Optionally, at 104, information may be encoded prior to coupling of the infiltrating component. For example, information may be encoded through the configuration of the infiltrating component (e.g., interspersed with non-infiltrating component). In some examples, encoding of information may also be provided by coupling a spacer having a selected configuration. In some examples, encoding of information may also be provided by a background layer. In some examples, the photonic crystal material may also be embedded with particles to effect encoding of information.

At 106, a suitable infiltrating component may be coupled to the photonic crystal material. In some examples, a spacer may be used between the infiltrating component and the photonic crystal material.

Optionally, at 107, at least a portion of the infiltrating component may be triggered to migrate into at least a portion of the photonic crystal material.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A photonic crystal device comprising:
a photonic crystal material having a periodic difference in refractive indices giving rise to a first reflectance spectrum; and
an infiltrating component;
wherein an external stimulus causes the infiltrating component to migrate into or migrate out of at least a portion of the photonic crystal material; and
wherein the migration of the infiltrating component into or out of at least the portion of the photonic crystal material causes a change of at least the portion of the photonic crystal material resulting in at least the portion of the photonic crystal material exhibiting a change from the first reflectance spectrum to a second reflectance spectrum that is detectably different from the first reflectance spectrum.

2. The photonic crystal device of claim 1 wherein the migration causes a change in a refractive index of at least one constituent of the infiltrated portion.

3. The photonic crystal device of claim 1 wherein the photonic crystal material has a first transmittance spectrum related to the first reflectance spectrum, and the change of at least the portion of the photonic crystal material also results in a change from the first transmittance spectrum to a second transmittance spectrum that is related to the second reflectance spectrum.

4. The photonic crystal device of claim 3 wherein the change from the first reflectance spectrum to the second reflectance spectrum includes a change in intensity of a reflectance peak, and the change from the first transmittance spectrum to the second transmittance spectrum includes a change in transmission values related to the change in the reflectance peak.

5. The photonic crystal device of claim 1 wherein the migration causes a change in a dimension of at least the portion of the photonic crystal material.

6. The photonic crystal device of claim 1 wherein at least a portion of at least one of the first or the second reflectance spectrum is in the visible spectrum.

7. The photonic crystal device of claim 1 wherein the infiltrating component is coupled to the photonic crystal material before migration into at least the portion of the photonic crystal material.

8. The photonic crystal device of claim 1 wherein the infiltrating component is a liquid.

9. The photonic crystal device of claim 1 wherein the infiltrating component is initially a solid that liquefies in response to the external stimulus, and wherein the liquefied infiltrating component is capable of migrating into at least the portion of the photonic crystal material.

10. The photonic crystal device of claim 1 further comprising a spacer separating the infiltrating component from the photonic crystal material before migration into at least the portion of the photonic crystal material.

11. The photonic crystal device of claim 10 wherein the spacer is responsive to the external stimulus to allow the infiltrating component to migrate into at least the portion of the photonic crystal material.

12. The photonic crystal device of claim 11 wherein the structural integrity of the spacer is reduced in response to the external stimulus, to allow the infiltrating component to migrate into at least the portion of the photonic crystal material.

13. The photonic crystal device of claim 1 wherein the migration of the infiltrating component results from a change in the phase of the infiltrating component, in response to the external stimulus.

14. The photonic crystal device of claim 13 wherein the change in the phase of the infiltrating component is from a solid phase to a liquid phase.

15. The photonic crystal device of claim 1 wherein the migration of the infiltrating component results from a change in the phase of the photonic crystal material, in response to the external stimulus.

16. The photonic crystal device of claim 15 wherein the change in the phase of the photonic crystal material is from a hydrophilic phase to a hydrophobic phase, or from a hydrophobic phase to a hydrophilic phase.

17. The photonic crystal device of claim 1 wherein the photonic crystal material has an inverse opal structure.

18. The photonic crystal device of claim 1 wherein the photonic crystal material has a Bragg stack structure.

19. The photonic crystal device of claim 1 further comprising one or more of: a substrate layer, an adhesive layer, a release layer, a background layer, and a protective layer.

20. The photonic crystal device of claim 1 wherein the infiltrating component migrates into or out of only predetermined portions of the photonic crystal material, thereby causing a predetermined image to be revealed in response to the external stimulus.

21. The photonic crystal device of claim 1 wherein the change from the first reflectance spectrum to a second reflectance spectrum is at least partially reversible.

22. The photonic crystal device of claim 21 wherein at least partial reversal from the second reflectance spectrum back to the first reflectance spectrum is in response to a further external stimulus.

23. The photonic crystal device of claim 1 wherein the photonic crystal material is provided as particles, and before the application of the external stimulus the infiltrating component is interspersed among the photonic crystal material particles.

24. A method for manufacturing a photonic crystal device, the method comprising:
providing a photonic crystal material having a periodic difference in refractive indices giving rise to a first reflectance spectrum; and
coupling an infiltrating component to the photonic crystal material;
wherein an external stimulus causes the infiltrating component to migrate into or out of at least a portion of the photonic crystal material, thereby causing a change of at least the portion of the photonic crystal material resulting in at least the portion of the photonic crystal material exhibiting a change from the first reflectance spectrum to a second reflectance spectrum that is detectably different from the first reflectance spectrum.
